(19) United States
(12) Patent Application Publication
(10) Pub. No.: US 2007/0063642 A1
(43) Pub. Date: Mar. 22, 2007

(54) Plasma display panel

(76) Inventors: Min Hur, Suwon-si (KR); Young-Do Choi, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/475,006

(22) Filed: Jun. 27, 2006

(30) Foreign Application Priority Data
Jun. 27, 2005 (KR) 10-2005-0055672

(51) Int. Cl. H01J 1/62

(52) U.S. Cl. 313/506

(57) ABSTRACT

A plasma display panel (PDP) includes a first substrate and a second substrate arranged opposite to each other with a space therebetween being partitioned into a plurality of discharge cells, phosphor layers in the discharge cells, address electrodes extending in a first direction between the first substrate and the second substrate and corresponding to each discharge cell, first and second electrodes extending in a second direction crossing the first direction between the first substrate and the second substrate and formed opposite to each other with a discharge cell interposed therebetween, the first electrodes and the second electrodes expanding from the first substrate toward the second substrate, and third electrodes extending in the second direction between the address electrodes and the second substrate, the third electrodes being disposed between the first electrodes and the second electrodes and protruding toward the first substrate.

### BACKGROUND OF THE INVENTION

1. Field of the Invention

The present invention relates to a plasma display panel (PDP). More particularly, the present invention relates to a PDP in which an electrode is provided between opposing electrodes in an opposed discharge structure to reduce discharge firing voltage and to enhance luminous efficiency.

2. Description of the Related Art

Generally, a plasma display panel (PDP) is a display device that excites phosphors with vacuum ultraviolet (VUV) rays radiated from plasma obtained through gas discharge and displays desired images with visible light generated by the excited phosphors. PDPs may be classified as a direct current (DC) type, an alternating current (AC) type and a hybrid type according to an applied discharge current. PDPs may also be classified as having a surface discharge structure and an opposed discharge structure.

In a DC PDP, electrons may directly collide with display electrodes, thereby damaging the electrodes. Thus, an AC PDP having a surface-discharge structure is widely used.

The AC PDP having a three-electrode surface discharge structure may include one substrate having sustain electrodes and scan electrodes on the same surface and another substrate that is spaced therefrom by a predetermined distance having address electrodes perpendicular to the sustain electrode and the scan electrode. A discharge gas may be provided between the substrates.

An address discharge may be determined by discharge between the independently controlled address electrodes and the scan electrodes, and a sustain discharge for displaying an image may be realized by discharge between the sustain electrodes and the scan electrodes located on the same surface.

Several steps may occur between initial generation of glow discharge and display of an image. When the glow discharge is generated, gas may be excited by collisions of electrons and gas and VUV rays may be generated from the excited gas. The VUV rays may collide with a phosphor layer in a discharge space to generate visible light. The visible light may pass through a transparent substrate to be viewed. In these steps, significant input energy applied to the sustain electrode and the scan electrode is dissipated.

The glow discharge may be generated by applying a voltage higher than a discharge firing voltage to two electrodes under an atmosphere of low pressure, e.g., less than 1 atm. The discharge firing voltage may be dependent on a particular gas used, a gas pressure and a distance between electrodes. In AC discharge, the discharge firing voltage may also be dependent on a capacitance of dielectric material, which in turn, depends on a dielectric constant of the dielectric material, an electrode area and thickness of the dielectric material, and a frequency of applied voltage.

In order to initiate discharge, a significantly high voltage is required. If the discharge is generated, a voltage distribution between an anode and a cathode is distorted by the space charge effect generated in a dielectric layer adjacent to the anode and the cathode. That is, a cathode sheath region adjacent to the cathode may consume most of the voltage applied to the two electrodes for discharge, an anode sheath region adjacent to the anode may consume a portion of the voltage and a positive column region formed between the two electrodes may consume very little voltage. Thus, in the cathode sheath region and the anode sheath region, most of the input energy is consumed, but in the positive column region, the input energy is barely consumed.

The high voltage causes the discharge gas to collide with electrons, raising the discharge gas to an excitation state. Upon discharge, in which the discharge gas transitions from an excitation state back to a ground state, VUV rays may be generated. The VUV rays may collide with the phosphor layer, which in turn, emits visible light. Accordingly, in order to increase a ratio of the input energy for generating visible light, i.e., luminous efficiency, the number of collisions of discharge gas and the electrons may be increased. Also, in order to increase the number of collisions of the discharge gas and the electrons, the electron heating efficiency may be increased.

Generally, the electron heating efficiency in the positive column region is higher than that in the cathode sheath region. Accordingly, high luminous efficiency in the PDP can be obtained by increasing the positive column region. Further, the cathode and anode sheath regions have substantially the same thickness under the same pressure regardless of applied voltage. Therefore, a discharge length needs to be increased to obtain high luminous efficiency.

However, in the PDP with the three-electrode structure, a discharge is initiated around the center region of the discharge space because, in the center region, a distance between the display electrodes is the shortest and the discharge firing voltage is the lowest. Then, the discharge is transferred to the edge region of the discharge space. That is, a strong discharge occurs in the center region and a weak discharge occurs in the edge region.

Therefore, the luminous efficiency is low in the center region because the discharge length is short, while the luminous efficiency is high in the edge region because the discharge length is long. In addition, the ratio of energy used to heat electrons to input energy is very low in the three-electrode surface-discharge structure, thereby reducing the luminous efficiency.

In order to overcome the above drawbacks in the three-electrode surface-discharge structure, long gap discharge may be used between the display electrodes. However, in order to initiate the long gap discharge, the discharge firing voltage must be increased, thus requiring a high voltage and increasing the cost of circuit elements.

The above information disclosed in this Background section is only for enhancement of understanding of the background of the invention, and therefore it may contain information that does not constitute prior art that is already known in this country to a person of ordinary skill in the art.

### SUMMARY OF THE INVENTION

The present invention is therefore directed to a plasma display panel (PDP), which substantially overcomes one or more of the problems due to the limitations and disadvantages of the related art.

It is therefore a feature of an embodiment of the present invention to provide a PDP that has reduced discharge firing voltage.

It is therefore another feature of an embodiment of the present invention to provide a PDP having increased luminous efficiency.

It is therefore yet another feature of an embodiment of the present invention to provide a PDP that controls two adjacent discharge spaces independently.

At least one of the above and other features and advantages of the present invention may be realized by providing a plasma display panel including a first substrate and a second substrate arranged opposite to each other, a space therebetween being partitioned into a plurality of discharge cells, phosphor layers in the discharge cells, address electrodes extending in a first direction between the first substrate and the second substrate and corresponding to each discharge cell, first electrodes and second electrodes extending in a second direction crossing the first direction between the first substrate and the second substrate, and formed opposite to each other with a discharge cell interposed therebetween, the first electrodes and the second electrodes expanding from the first substrate toward the second substrate, and third electrodes extending in the second direction between the address electrodes and the second substrate, the third electrodes disposed between the first electrodes and the second electrodes and protruding toward the first substrate.

The first electrodes and the second electrodes may be at boundaries of adjacent discharge cells in the first direction, and may be alternately arranged in the first direction.

The third electrodes may include expanding electrode portions protruding toward the first electrodes and the second electrodes in each discharge cell. The expanding electrode portions may each form a quadrangle or may be rounded.

The address electrodes may include protruding portions formed to protrude toward the third electrodes in each discharge cell. The address electrodes may include large electrode portions formed to expand in the second direction in each discharge cell. The large electrode portions may each form an octagon.

The third electrodes may include expanding electrode portions protruding toward the first electrodes and the second electrodes in each discharge cell, and the address electrode may include large electrode portions formed to expand in the second direction in each discharge cell, wherein 2W2<W1<4W2 and 2H2<H1<4H2, when each large electrode portion has a width W1 and a height H1, and each expanding electrode portion has a width W2 and a height H2.

The first electrodes and the second electrodes may be covered with a dielectric layer defining each discharge cell. The plasma display panel may include a first barrier rib layer formed adjacent to the first substrate to define each discharge cell and/or a second barrier rib layer formed adjacent to the second substrate to define each discharge cell. The dielectric layer may be opaque.

The phosphor layer may include a first phosphor layer formed on the rear substrate. The address electrodes may include protruding portions protruding toward the third electrodes in each discharge cell and the phosphor layer may cover at least a surface of the protruding portions. The first phosphor layer may be a reflective phosphor material.

The phosphor layer may include a second phosphor layer on the front substrate. The second phosphor layer may cover at least a surface of the third electrodes. The second phosphor layer may be a transmissive phosphor material.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial exploded perspective view of a PDP according to a first exemplary embodiment of the present invention;

FIG. 2 illustrates a partial cross-sectional side view taken along the line II-II of the PDP of FIG. 1;

FIG. 3 illustrates a schematic partial plan view of the structure of electrodes in the PDP according to the first exemplary embodiment of the present invention;

FIG. 4 illustrates a schematic partial plan view of the structure of electrodes in a PDP according to a second exemplary embodiment of the present invention;

FIG. 5 illustrates a schematic partial plan view of the structure of electrodes in a PDP according to a third exemplary embodiment of the present invention;

FIG. 6 illustrates a partial cross-sectional side view of a PDP according to a fourth exemplary embodiment of the present invention;

FIG. 7 illustrates a schematic partial plan view of the structure of electrodes in a PDP according to a fifth exemplary embodiment of the present invention;

FIG. 8 illustrates a partially enlarged plan view of a portion VIII in the PDP of FIG. 7; and

FIG. 9 illustrates a partial cross-sectional view of a PDP according to a sixth exemplary embodiment of the present invention.

### DETAILED DESCRIPTION OF THE EMBODIMENTS

Korean Patent Application No. 10-2005-0055672, filed on Jun. 27, 2005, in the Korean Intellectual Property Office and entitled: “Plasma Display Panel” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

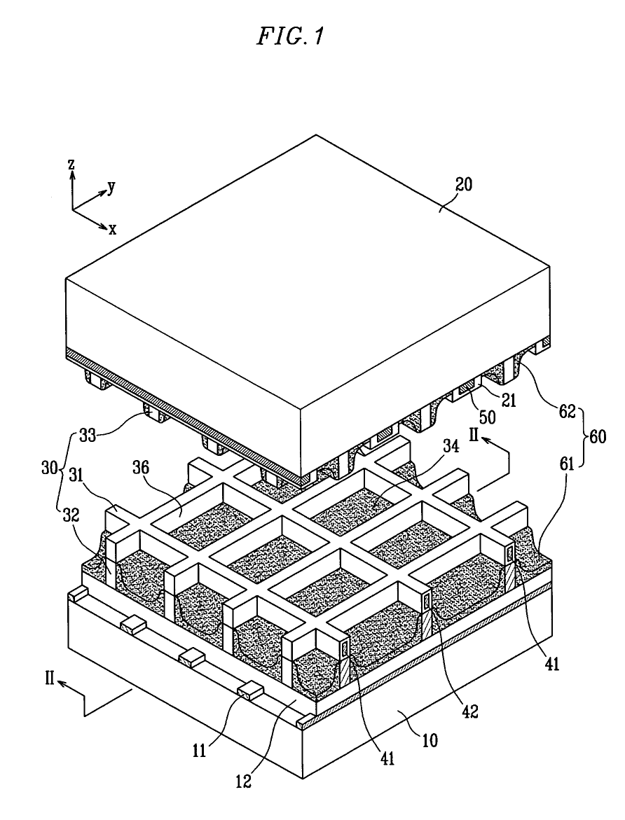

FIG. 1 illustrates a partial exploded perspective view of a plasma display panel (PDP) according to a first exemplary embodiment of the present invention. Referring to FIG. 1, a PDP according to the first exemplary embodiment may include a first substrate 10 (hereinafter referred to as a “rear substrate”) and a second substrate 20 (hereinafter referred to as a “front substrate”) arranged opposite to each other with a predetermined distance therebetween, and barrier ribs 30 defining a plurality of discharge cells provided between the rear substrate 10 and the front substrate 20.

In a discharge space 34 of each discharge cell, a luminescent material for emitting visible light may be provided. For example, phosphor layers 60 for absorbing vacuum ultraviolet (VUV) rays and emitting visible light may be provided in each discharge space 34. A discharge gas, e.g., a gas mixture containing xenon (Xe) and neon (Ne), may fill the discharge spaces 34 to generate VUV rays by plasma discharge.

Address electrodes 11 may be formed extending in a first direction (y-axis direction in the drawing) on an inner surface of the rear substrate 10 opposite to the front substrate 20. A lower dielectric layer 12 covering the address electrodes 11 may be formed over an entire surface of the rear substrate 10. The address electrodes 11 may be arranged in parallel to one another along a second direction (x-axis direction in the drawing) crossing the first direction (y-axis direction in the drawing) to correspond to each discharge space 34.

First electrodes 41 and second electrodes 42 may extend in the second direction (x-axis direction in the drawing) and may be alternately arranged along the first direction (y-axis direction in the drawing) with discharge spaces 34 interposed therebetween. That is, the first electrodes 41 and the second electrodes 42 may be disposed on boundaries between adjacent discharge spaces 34 in the first direction (y-axis direction in the drawing).

Accordingly, a pair of adjacent discharge spaces 34 in the first direction (y-axis direction in the drawings) may share either the first electrodes 41 or the second electrodes 42, and the first electrodes 41 and the second electrodes 42 may participate in sustain discharges in the pair of adjacent discharge spaces 34, respectively.

In the present exemplary embodiment, each discharge space 34 may be defined by the barrier ribs 30 as a quadrangle. However, the present invention is not limited to the present embodiment, and discharge spaces may be formed in various shapes, e.g. a circular, an elliptical, and a polygonal shape.

The barrier ribs 30 may include a dielectric layer 31, a first barrier rib layer 32, and a second barrier rib layer 33. The dielectric layer 30 may cover the first electrodes 41 and the second electrodes 42. The first barrier rib layer 32 may be formed adjacent to the rear substrate 10, and the second barrier rib layer 33 may be formed adjacent to the front substrate 20. In addition, the first barrier rib layer 32 may be opposite to the second barrier rib layer 33 with the dielectric layer 31 interposed therebetween. Accordingly, the dielectric layer 31, the first barrier rib layer 32 and the second barrier rib layer 33 may define the discharge spaces 34.

Alternatively, only the dielectric layer 31 may be provided to define the discharge spaces 34, only the dielectric layer 31 and the first barrier rib layer 32, or only the dielectric layer 31 and the second barrier rib layer 33 may be provided to define the discharge spaces 34.

Since the dielectric layer 31 defines each discharge space 34 between the front substrate 20 and the rear substrate 10 and does not block visible light emitted from the discharge spaces 34, the dielectric layer 31 may be made of an opaque, e.g., a black, dielectric material. Accordingly, bright room contrast ratio may be increased.

A protective layer 36 may be formed on the surfaces of the dielectric layer 31. Particularly, the protective layer 36 may be formed on the surfaces of the dielectric layer 31 that are exposed to the plasma discharge generated in the discharge spaces 34. The protective layer 36 may protect the dielectric layer 31 and may have a high secondary electron emission coefficient. The protective layer 36 in the present exemplary embodiment may be opaque.

For example, the protective layer 36 may be made of an opaque MgO. The opaque MgO may have a higher secondary electron emission coefficient compared to transparent MgO, thereby further reducing the discharge firing voltage.

Third electrodes 50 may be formed on an inner surface of the front substrate 20 opposite to the rear substrate 10. The third electrodes 51 may extend in the second direction (x-axis direction in the drawing) between the first and second electrodes 41 and 42, and may protrude toward the address electrodes 11.

The phosphor layer 60 may include a first phosphor layer 61 and a second phosphor layer 62. The first phosphor layer 61 may be formed on the rear substrate 10, and the second phosphor layer 62 may be formed on the front substrate 20. However, the present invention is not limited to the present embodiment. For example, only the first phosphor layer or the second phosphor layer may be formed.

The first phosphor layer 61 may be formed on the first barrier rib layer 32, and the second phosphor layer 62 may be formed on the second barrier rib layer 33, in addition to the rear and front substrate 10 and 20. Specifically, the first phosphor layer may be formed on side surfaces of the first barrier rib layer 32, and the second phosphor layer 62 may be formed on side surfaces of the second barrier rib layer 33, thereby improving the luminous efficiency. For the same reason, the second phosphor layer 62 may be formed on side surfaces of the third electrodes 50.

The first phosphor layer 61 may absorb VUV rays in the discharge spaces 34 and may emit visible light directed toward the front substrate 20. The second phosphor layer 62 may absorb VUV rays in the discharge space 34 and may emit visible light directed toward the front substrate 20. For this purpose, the first phosphor layer 61 may be made of reflective phosphors that reflect visible light, and the second phosphor layer 62 may be made of transmissive phosphors that transmit visible light.

In addition, a thickness of the first phosphor layer 61 in the rear substrate 10 may be greater than a thickness of the second phosphor layer 62 in the front substrate 20 in order to increase reflective efficiency or transmissive efficiency with respect to visible light. In other words, each particle size of phosphor powders forming the first phosphor layer 61 may be larger than each particle size of phosphor powders forming the second phosphor layer 62.

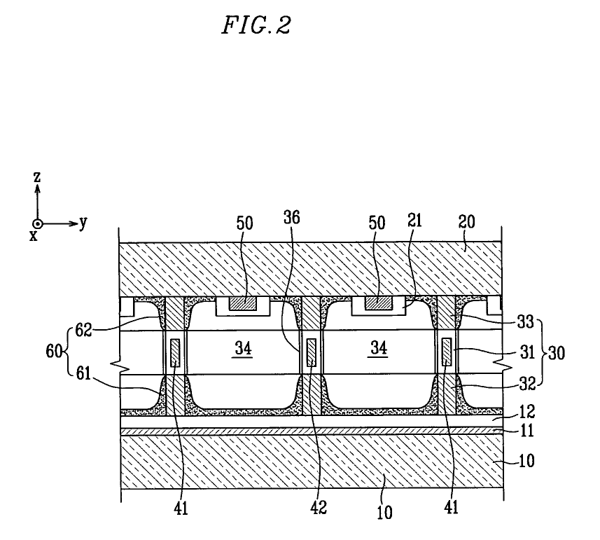

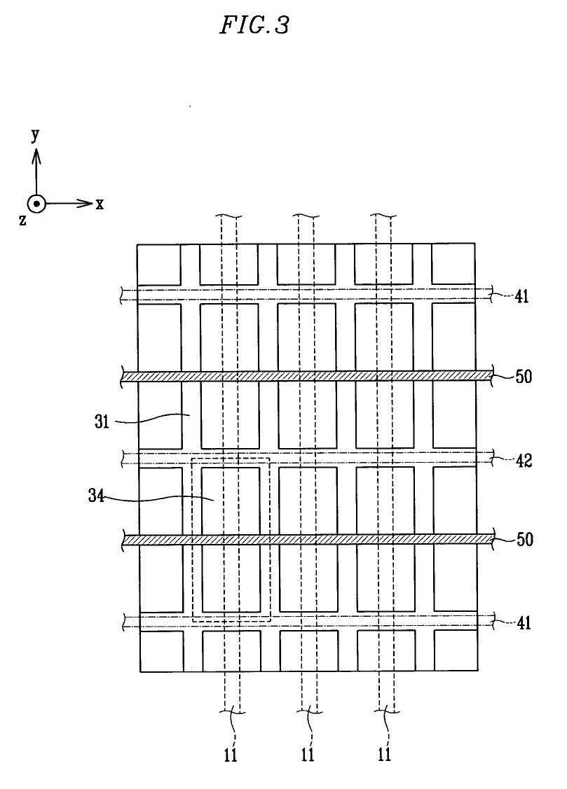

FIG. 2 illustrates a partial cross-sectional side view taken along the line II-II of the PDP of FIG. 1, and FIG. 3 illustrates a schematic partial plan view of the structure of electrodes in the PDP according to the first exemplary embodiment of the present invention.

Referring to FIG. 2 and FIG. 3, in the reset period, the third electrodes 50 may participate in reset discharge together with the first electrodes 41 or the second electrodes 42. In the address period, the third electrodes 50 may participate in address discharge together with the address electrodes 11, thereby selecting discharge spaces 34 to be turned on. In the sustain period, the third electrodes 50 may participate in sustain discharge together with the first and second electrodes 41 and 42, thereby displaying images.

Since the third electrodes 50 may participate in the address discharge in the present exemplary embodiment, adjacent discharge spaces 34 in the first direction (y-axis direction in the drawings) can be independently selected in the address period. That is, two adjacent discharge spaces 34 in the first direction can be selected independently although the first and second electrodes 41 and 42 are alternately disposed at boundaries between adjacent discharge spaces along the first direction. In addition, a distance between the third electrodes 50 and the address electrodes 11 may be reduced because the third electrodes 50 protrude from the front substrate 20 toward the rear substrate 10. Thus, the address discharge voltage can be reduced and the address discharge between the third electrodes 50 and the address electrodes 11 can be easily performed with a low voltage. In addition, the third electrodes 50 may protrude such that the third electrodes 50 do not obstruct the opposed discharge between the first electrodes 41 and the second electrodes 42 in the sustain period.

A dielectric layer 21 may cover the third electrodes 50 such that the third electrodes 50 are not exposed to plasma discharge in the discharge spaces 34. When the dielectric layer 21 is disposed in the center region of the discharge spaces 34, the dielectric layer 21 may block visible light emitted from the discharge spaces 34. Therefore, the dielectric layer 21 may be formed of a dielectric material to transmit visible light in order to minimize the blockage with respect to visible light.

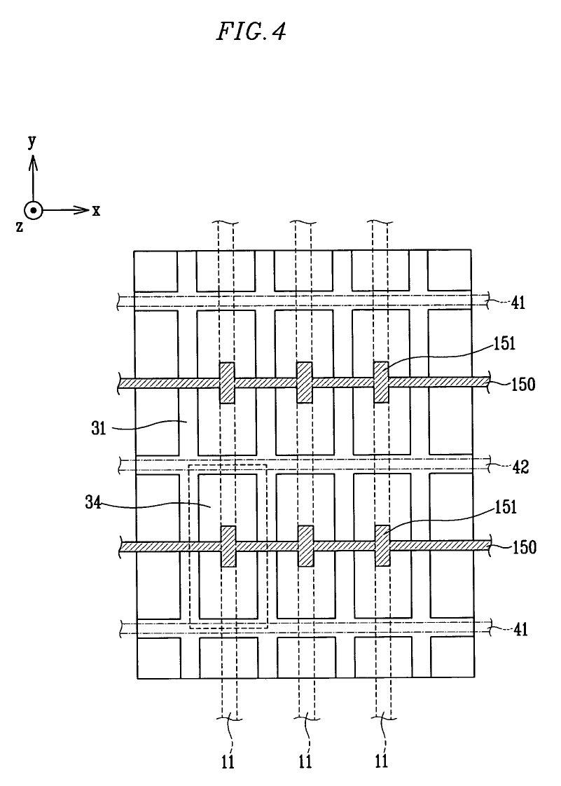

FIG. 4 illustrates a schematic partial plan view of the structure of electrodes in a PDP according to a second exemplary embodiment of the present invention.

Referring to FIG. 4, third electrodes 150 may be disposed opposite to the address electrodes 11 and formed to extend in the second direction crossing the address electrodes 11. In addition, the third electrodes 150 may include expanding electrode portions 151 protruding toward the first and second electrodes 41 and 42 in each discharge space 34 and may be formed as a quadrangle. Accordingly, the expanding electrode portions 151 can increase the facing area between the third electrodes 150 and the address electrodes 11, and decrease a gap between the third electrodes 150 and the first and second electrodes 41 and 42 to reduce the discharge firing voltage.

The third electrodes 150 and the expanding electrode portions 151 may be formed of a transparent material such as indium tin oxide (ITO) in order to increase transmissive efficiency with respect to visible light. Alternatively, the third electrodes 150 and the expanding electrode portions 151 may be formed with minimized widths in order to increase transmissive efficiency with respect to visible light.

As described above, the address discharge voltage and the sustain discharge voltage may be reduced by the expanding electrode portions 151. Specifically, in the address period, the address discharge may be initiated with a low voltage by increasing the facing area between the address electrodes 11 and the third electrodes 150. In the sustain period, a triggering discharge may occur between the expanding electrode portions 151 and the first electrodes 41 or between the expanding electrode portions 151 and the second electrodes 42. Then, the triggering discharge may induce a long gap discharge between the first electrodes 41 and the second electrodes 42, and thereby increase the luminous efficiency. However, because the function may be changed depending on a signal voltage that is applied to each electrode, the present invention is not limited thereto.

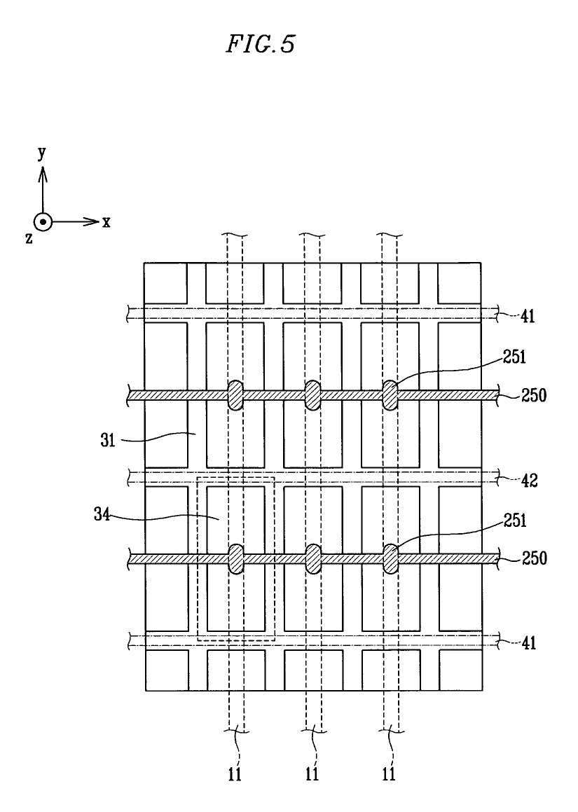

FIG. 5 illustrates a schematic partial plan view of the structure of electrodes in a PDP according to a third exemplary embodiment of the present invention.

Referring to FIG. 5, expanding electrode portions 251 according to the present exemplary embodiment may protrude from third electrodes 250 toward the first and second electrodes 41 and 42 in each discharge space 34. However, unlike in the second exemplary embodiment, the expanding electrode portions 251 may be rounded. Expanding electrode portions may be formed in various shapes, e.g., a circle or an ellipse.

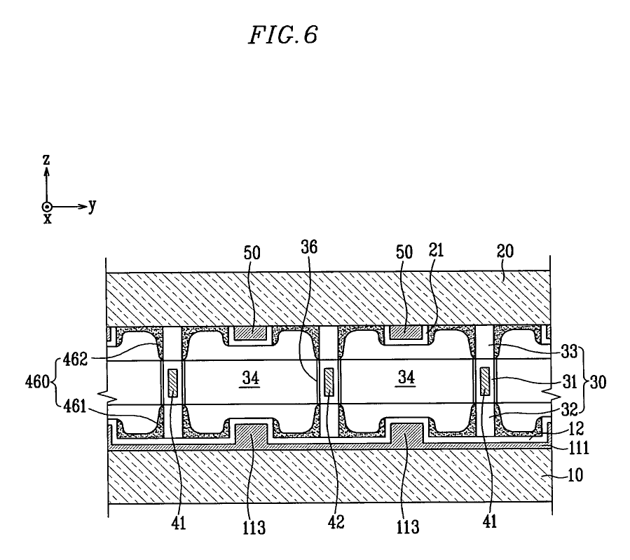

FIG. 6 illustrates a partial cross-sectional side view of a PDP according to a fourth exemplary embodiment of the present invention. Referring to FIG. 6, address electrodes 111 may include protruding portions 113 that protrude therefrom toward the third electrodes 30 in each discharge space 34. Thus, the protruding portions 113 may be formed opposite to the third electrodes 50. In addition, like the third electrodes 50, the protruding portions 113 may protrude such that they do not obstruct the opposed discharge between the first electrodes 41 and the second electrodes 42 in the sustain period.

When the address electrodes 111 include the protruding portions 113, a distance between the third electrodes 50 and the address electrodes 111 can be further reduced. Accordingly, address discharge voltage can be reduced, thereby improving the discharge efficiency.

In addition, a phosphor layer 460 may include first and second phosphor layers 461 and 462. The first phosphor layer 461 may be on side surfaces of the protruding portions 113 as well as on the rear substrate 10. Accordingly, the area of the first phosphor layer exposed to the discharge spaces 34 may be increased, thereby improving the luminous efficiency. For the same reason, the second phosphor layer 462 may be on side surfaces of the third electrodes 50 as well as on the front substrate 20. In addition, the first phosphor layer 461 may be on the first barrier rib 32 and the second phosphor layer 462 may be formed on the second barrier rib 33.

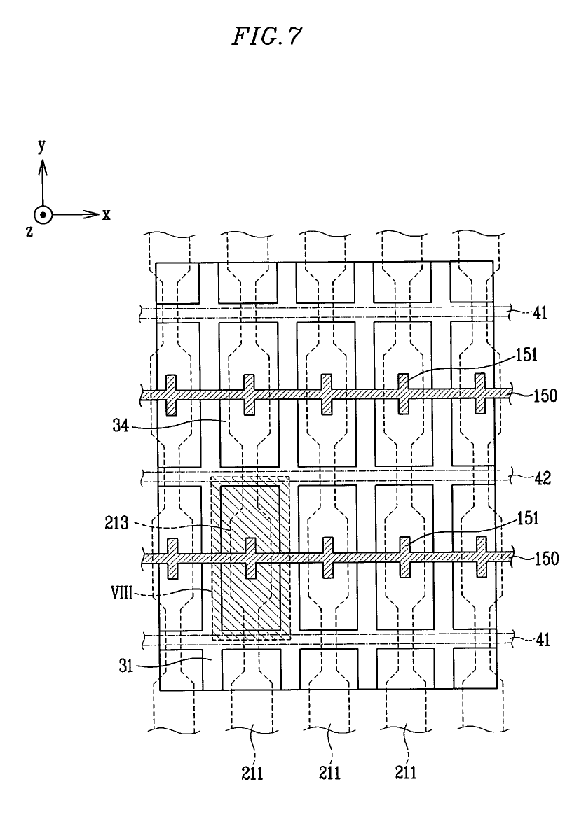

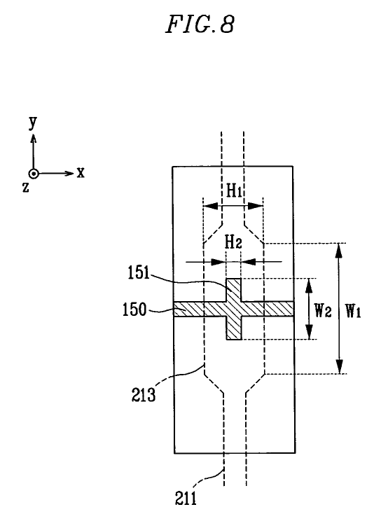

FIG. 7 illustrates a schematic partial plan view of the structure of electrodes in a PDP according to a fifth exemplary embodiment of the present invention, and FIG. 8 illustrates a partially enlarged plan view of a portion VIII in the PDP of FIG. 7.

Referring to FIG. 7 and FIG. 8, address electrodes 211 may include large electrode portions 213 formed at locations corresponding to each discharge space 34. The large electrode portions 213 may be opposite the third electrodes 150, thereby increasing discharge areas between the address electrodes 211 and the third electrodes 150.

The large electrode portions 213 may expand in the second direction (x-axis direction in the drawings) crossing the address electrodes 211. Preferably, the large electrode portions 213 may be formed in the center region of each discharge space 34, where address discharge is substantially performed.

In the present exemplary embodiment, the large electrode portions 213 are formed as an octagon. However, the present invention is not limited to the present exemplary embodiment, and the large electrode portions may be formed in various shapes, e.g., a quadrangle, a circle, an ellipse, and a polygon.

In addition, the large electrode portions 213 may be disposed opposite to the expanding electrode portions 151, thereby increasing the discharge area between the address electrodes 211 and the third electrodes 150.

As described above, dimensions of the expanding electrode portions 151 are limited according to a transmissive efficiency with respect to visible light. In the present embodiment, dimensions of the large electrode portions 231 may be related to the dimensions of the expanding electrode portions 151. For example, as shown in FIG. 8, when the large electrode portions 213 have a width W1 and a height H1, and the expanding electrode portions 151 have a width W2 and a height H2, W1 may be set between 2W2 and 4W2, and H1 may be set between 2H2 and 4H2. In other words, in the present embodiment, these dimensions may satisfy the relationships 2W2<W1<4W2 and 2H2<H1<4H2. With these relationships, the large electrode portions 213 may be disposed in a discharge region where discharge is substantially performed in the discharge spaces 34.

Thus, the large electrode portions 213 may increase the discharge area between the address electrodes 211 and the third electrodes 150, thereby reducing the address discharge voltage and improving the discharge efficiency.

In addition, the large electrode portions 213 may be formed to protrude toward the third electrode portions 150 to further improve the discharge efficiency, as shown in the fourth exemplary embodiment.

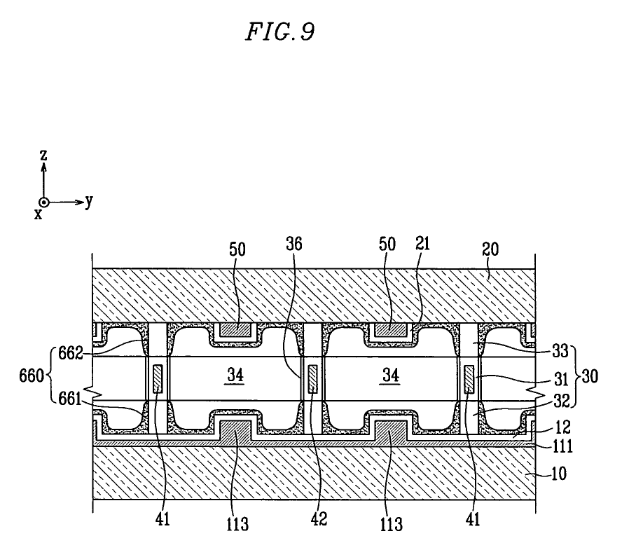

FIG. 9 illustrates a partial cross-sectional view of a PDP according to a sixth exemplary embodiment of the present invention. Referring to FIG. 9, a phosphor layer 660 according to the sixth exemplary embodiment may cover the protruding portions 113 of the address electrodes 111 and the third electrodes 50. That is, a first phosphor layer 661 may cover the protruding portions 113, and a second phosphor layer 662 may cover the third electrodes 50. Accordingly, the area of the first phosphor layer 661 and the second phosphor layer 662 exposed to the discharge spaces 34 may be increased, thereby improving the luminous efficiency.

As described above, in the plasma display panel (PDP) according to the exemplary embodiments of the present invention, first and second electrodes participating in sustain discharge are disposed opposite to each other with discharge spaces interposed therebetween, and third electrodes participating in reset discharge and address discharge are disposed between the first and second electrodes. Thus, the sustain discharge may be an opposed discharge, thereby improving the luminous efficiency. Further, the discharge firing voltage may be lowered by decreasing a gap between the first and second electrodes and the third electrodes, thereby improving the discharge efficiency.

In addition, address discharge voltage may be lowered by providing large electrode portions of the address electrodes and/or by protruding portions of the address electrodes. Since the third electrodes between the first electrodes and the second electrodes participate in the address discharge, two adjacent discharge spaces may be independently selected in the address period.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
a first substrate and a second substrate arranged opposite to each other, a space therebetween being partitioned into a plurality of discharge cells;
phosphor layers in the discharge cells;
address electrodes extending in a first direction between the first substrate and the second substrate and corresponding to each discharge cell;
first electrodes and second electrodes extending in a second direction crossing the first direction between the first substrate and the second substrate, and formed opposite to each other with a discharge cell interposed therebetween, the first electrodes and the second electrodes expanding from the first substrate toward the second substrate; and
third electrodes extending in the second direction between the address electrodes and the second substrate, the third electrodes disposed between the first electrodes and the second electrodes and protruding toward the first substrate.

2. The plasma display panel as claimed in claim 1, wherein the first electrodes and the second electrodes are at boundaries of adjacent discharge cells in the first direction, and are alternately arranged in the first direction.

3. The plasma display panel as claimed in claim 1, wherein the third electrodes further comprise expanding electrode portions protruding toward the first electrodes and the second electrodes in each discharge cell.

4. The plasma display panel as claimed in claim 3, wherein the expanding electrode portions each form a quadrangle.

5. The plasma display panel as claimed in claim 3, wherein the expanding electrode portions are rounded.

6. The plasma display panel as claimed in claim 1, wherein the address electrodes comprise protruding portions formed to protrude toward the third electrodes in each discharge cell.

7. The plasma display panel as claimed in claim 1, wherein the address electrodes further comprise large electrode portions formed to expand in the second direction in each discharge cell.

8. The plasma display panel as claimed in claim 7, wherein the large electrode portions each form an octagon.

9. The plasma display panel as claimed in claim 1, wherein:
the third electrodes include expanding electrode portions protruding toward the first electrodes and the second electrodes in each discharge cell; and
the address electrode include large electrode portions formed to expand in the second direction in each discharge cell, and
wherein 2W2<W1<4W2 and 2H2<H1<4H2, when each large electrode portion has a width W1 and a height H1, and each expanding electrode portion has a width W2 and a height H2.

10. The plasma display panel as claimed in claim 1, wherein the first electrodes and the second electrodes are covered with a dielectric layer defining each discharge cell.

11. The plasma display panel as claimed in claim 10, further comprising a first barrier rib layer formed adjacent to the first substrate to define each discharge cell.

12. The plasma display panel as claimed in claim 11, further comprising a second barrier rib layer formed adjacent to the second substrate to define each discharge cell.

13. The plasma display panel as claimed in claim 10, further comprising a second barrier rib layer formed adjacent to the second substrate to define each discharge cell.

14. The plasma display panel as claimed in claim 10, wherein the dielectric layer is made of an opaque dielectric material.

15. The plasma display panel as claimed in claim 1, wherein the phosphor layer comprises a first phosphor layer formed on the rear substrate.

16. The plasma display panel as claimed in claim 15, wherein the address electrodes comprise protruding portions protruding toward the third electrodes in each discharge space and the phosphor layer covers at least a surface of the protruding portions.

17. The plasma display panel as claimed in claim 15, wherein the first phosphor layer is a reflective phosphor material.

18. The plasma display panel as claimed in claim 1, wherein the phosphor layer comprises a second phosphor layer on the front substrate.

19. The plasma display panel as claimed in claim 18, wherein the second phosphor layer covers at least a surface of the third electrodes.

20. The plasma display panel as claimed in claim 18, wherein the second phosphor layer is a transmissive phosphor material.
